(19) United States
(12) Patent Application Publication
(10) Pub. No.: US 2025/0074411 A1
(43) Pub. Date: Mar. 6, 2025

(54) VEHICLE DRIVING CONTROL METHOD AND VEHICLE CONTROL DEVICE

(71) Applicants: HYUNDAI MOTOR COMPANY, SEOUL (KR); KIA CORPORATION, SEOUL (KR)

(72) Inventors: Sung Jae Oh, Hwaseong-si (KR); Jun Yong Lee, Seongnam-si (KR); Jin Kyeom Cho, Suwon-si (KR); Sung Ik Jo, Hwaseong-si (KR); Ji Hun Choi, Goyang-si (KR); Seung Eun Yu, Bucheon-si (KR); Sung Ho Kim, Hwaseong-si (KR)

(21) Appl. No.: 18/411,657

(22) Filed: Jan. 12, 2024

(30) Foreign Application Priority Data
Sep. 4, 2023 (KR) 10-2023-0117078

(51) Int. Cl. B60W 30/14; B60W 30/09; B60W 30/095; B60W 30/182; B60W 50/00

(52) U.S. Cl. CPC B60W 30/143; B60W 30/09; B60W 30/0956; B60W 30/182; B60W 50/0098; B60W 2050/0083; B60W 2520/10; B60W 2554/80

(57) ABSTRACT

A vehicle control device and a vehicle driving control method include comparing a vehicle's speed with a predetermined first reference speed when a motion sickness prevention mode is entered based on user-configured information about whether to activate the motion sickness prevention mode during driving of the vehicle, and controlling, based on a result of the comparison with the first reference speed, the vehicle to reduce a change in longitudinal acceleration of the vehicle or reduce a feeling of acceleration or deceleration experience by a passenger in the vehicle in consideration of whether an obstacle is recognized.

### CROSS REFERENCE TO RELATED APPLICATIONS

This application is based on and claims priority under 35 U.S.C. 119 to Korean Patent Application No. 10-2023-0117078, filed on Sep. 4, 2023, in the Korean Intellectual Property Office, the disclosure of which is herein incorporated by reference in its entirety.

### BACKGROUND

### Technical Field

The present disclosure relates to a vehicle control device and a vehicle driving control method for controlling the driving of a vehicle to reduce motion sickness of a passenger riding in the vehicle.

### BACKGROUND

With the recent advancement of various sensors and recognition systems, driver assistance systems and autonomous driving systems that consider driver convenience and safety can control the driving of a vehicle without a driver's intervention.

However, as the amount of time spent in a vehicle increases, passengers in the vehicle may experience motion sickness when the passengers are in the vehicle for a long time or are in a traffic jam area with repeated stops and starts. Motion sickness may occur due to various causes, and in particular, discomfort due to perceptual disparity between the field of view and longitudinal or lateral acceleration may be the most significant cause of motion sickness.

As described above, in a traffic jam area, the frequent occurrence of acceleration or deceleration of the vehicle causes a sudden change in longitudinal acceleration, thereby causing motion sickness of the passengers. However, in the past, attempts were made to prevent motion sickness in passengers by detecting the motion sickness and only controlling a vehicle in the lateral direction or controlling a seat.

Therefore, in order to reduce motion sickness of passengers, it is necessary to develop a method for preventing frequent abrupt changes in longitudinal acceleration depending on the driving situation of the vehicle or addressing discomfort due to perceptual disparity between the field of view and longitudinal acceleration.

In addition, it is necessary to develop a method for reducing motion sickness in passengers while ensuring the safety of the vehicle and the passengers.

The foregoing described as the background art is intended merely to aid in the understanding of the background of the present disclosure, and is not intended to mean that the present disclosure falls within the purview of the related art already known to those skilled in the art.

### SUMMARY

The present disclosure has been proposed to solve the above-mentioned problems, and it is an aspect of the present disclosure to provide a vehicle control device and a vehicle driving control method, wherein control is performed to prevent frequent abrupt changes in longitudinal acceleration depending on the driving situation of the vehicle or to address discomfort due to perceptual disparity between the field of view and longitudinal acceleration, and separate control release conditions are established to ensure that no control is executed in situations where control is not possible.

The technical subjects pursued in the present disclosure may not be limited to the above-mentioned technical subjects, and other technical subjects which are not mentioned may be clearly understood, through the following descriptions, by those skilled in the art to which the present disclosure pertains.

In order to achieve the above aspect, a vehicle driving control method according to the present disclosure may include comparing a vehicle's speed with a predetermined first reference speed when a motion sickness prevention mode is entered based on user-configured information about whether to activate the motion sickness prevention mode during driving of the vehicle, and controlling, based on a result of the comparison with the first reference speed, the vehicle to reduce a change in longitudinal acceleration of the vehicle or reduce a feeling of acceleration or deceleration experienced by a passenger in the vehicle based on whether an obstacle is recognized.

For example, the comparing may include determining whether a driving function based on target vehicle speed tracking is active, when the motion sickness prevention mode is entered, and comparing the vehicle's speed with the first reference speed when the driving function is active.

For example, the method may include, before the controlling, determining, when the motion sickness prevention mode is entered, one preconfigured detailed setting mode from among multiple detailed setting modes that have different degrees of control intervention based on entering the motion sickness prevention mode, and controlling the vehicle based on the comparison result based on the one determined detailed setting mode.

For example, the controlling may include controlling the vehicle in a low-speed driving mode, in which the change in longitudinal acceleration of the vehicle is reduced, when the vehicle speed is equal to or lower than the first reference speed as a result of the comparison, and controlling, when the vehicle speed exceeds the first reference speed, the vehicle in a high-speed driving mode in which at least one of an obstacle in front of the vehicle and the driving function based on target vehicle speed tracking is active is a mode release condition and the feeling of acceleration or deceleration experienced by the passenger in the vehicle is reduced.

For example, the controlling may include determining whether the vehicle is accelerating or decelerating when the vehicle speed is equal to or lower than the first reference speed, and controlling the vehicle in a first low-speed driving mode, in which the longitudinal acceleration of the vehicle is restricted, in case that the vehicle is accelerating as a result of the determination, and controlling the vehicle in a second low-speed driving mode, in which neutral N is applied when the vehicle's speed reaches a predetermined second reference speed, when the vehicle is decelerating.

For example, the controlling may include determining whether there is an obstacle in front of the vehicle in case that the vehicle speed exceeds the first reference speed, and controlling the vehicle in the high-speed driving mode when the obstacle is not present.

For example, the determining may include determining whether the obstacle is present within a predetermined reference distance from the vehicle by using a sensor unit provided in the vehicle.

For example, the controlling may include controlling the vehicle in the high-speed driving mode when the driving function is active in case that the obstacle is present.

For example, the controlling may include determining whether the vehicle is accelerating or decelerating when the vehicle speed exceeds the first reference speed, and controlling the vehicle in a first high-speed driving mode, which is based on an acceleration torque profile generated to reduce the passenger's feeling of acceleration, when the vehicle is accelerating as a result of the determination, and controlling the vehicle in a second high-speed driving mode, which is based on a deceleration torque profile generated to reduce the passenger's feeling of deceleration, when the vehicle is decelerating.

In addition, in order to achieve the above aspect, a vehicle control device according to the present disclosure may include a determination unit configured to compare a vehicle's speed with a predetermined first reference speed when a motion sickness prevention mode is entered based on user-configured information about whether to activate the motion sickness prevention mode during driving of the vehicle, and a controller configured to control, based on a result of the comparison with the first reference speed performed by the determination unit, the vehicle to reduce a change in longitudinal acceleration of the vehicle or reduce a feeling of acceleration or deceleration experienced by a passenger in the vehicle based on whether an obstacle is recognized.

For example, the determination unit may be configured to determine whether a driving function based on target vehicle speed tracking is active, when the motion sickness prevention mode is entered, and to compare the vehicle's speed with the first reference speed when the driving function is active.

For example, the determination unit may be configured to determine, when the motion sickness prevention mode is entered, one preconfigured detailed setting mode from among multiple detailed setting modes that have different degrees of control intervention based on entering the motion sickness prevention mode, and the controller may be further configured to control the vehicle based on the comparison result based on the one detailed setting mode determined by the determination unit.

For example, the controller may be further configured to control the vehicle in a low-speed driving mode, in which the change in longitudinal acceleration of the vehicle is reduced, when the vehicle speed is equal to or lower than the first reference speed as a result of the comparison by the determination unit, and to control, when the vehicle speed exceeds the first reference speed, the vehicle in a high-speed driving mode in which at least one of an obstacle in front of the vehicle and the driving function based on target vehicle speed tracking is active is a mode release condition and the feeling of acceleration or deceleration experienced by the passenger in the vehicle is reduced.

For example, the controller may be further configured to determine whether the vehicle is accelerating or decelerating when the vehicle speed is equal to or lower than the first reference speed, and control the vehicle in a first low-speed driving mode, in which the longitudinal acceleration of the vehicle is restricted, in case that the vehicle is accelerating as a result of the determination and control the vehicle in a second low-speed driving mode, in which neutral N is applied when the vehicle's speed reaches a predetermined second reference speed, when the vehicle is decelerating.

For example, the controller may be further configured to determine whether there is an obstacle in front of the vehicle when the vehicle speed exceeds the first reference speed, and to control the vehicle in the high-speed driving mode when the obstacle is not present.

For example, the controller may be further configured to determine whether the obstacle is present within a predetermined reference distance from the vehicle by using a sensor unit provided in the vehicle.

For example, the controller may be further configured to control the vehicle in the high-speed driving mode when the driving function is active in case that the obstacle is present.

For example, the controller may be further configured to determine whether the vehicle is accelerating or decelerating when the vehicle speed exceeds the first reference speed, and to control the vehicle in a first high-speed driving mode, which is based on an acceleration torque profile generated to reduce the passenger's feeling of acceleration, in case that the vehicle is accelerating as a result of the determination, and control the vehicle in a second high-speed driving mode, which is based on a deceleration torque profile generated to reduce the passenger's feeling of deceleration, when the vehicle is decelerating.

As described above, the vehicle driving control method and the vehicle control device, according to the present disclosure, may compare a vehicle's speed with a predetermined first reference speed, and may control the vehicle in a low-speed driving mode, in which a change in longitudinal acceleration of the vehicle is reduced, when the vehicle speed is equal to or lower than the first reference speed as a result of the comparison, and may control, when the vehicle speed exceeds the first reference speed, the vehicle in a high-speed driving mode in which a feeling of acceleration or deceleration experience by a passenger in the vehicle is reduced. Therefore, the vehicle driving control method and the vehicle control device may prevent the occurrence of an abrupt change in longitudinal acceleration or reduce discomfort related to the passenger's feeling of acceleration or deceleration, thus preventing the passenger from experiencing motion sickness.

In addition, by providing a separate release condition when controlling the vehicle in the high-speed driving mode, the safety of both the vehicle and the passenger may be prioritized in situations where control is impossible.

Advantageous effects obtainable from the present disclosure may not be limited to the above-mentioned effects, and other effects which are not mentioned may be clearly understood, through the following descriptions, by those skilled in the art to which the present disclosure pertains.

### BRIEF DESCRIPTION OF THE FIGURES

The above and other aspects, features, and advantages of the present disclosure will be more apparent from the following detailed description taken in conjunction with the accompanying drawings, in which:

FIG. 1 is a block diagram illustrating the configuration of a vehicle control device according to an embodiment of the present disclosure;

FIGS. 2 to 3 are graphs illustrating acceleration and deceleration situations of a vehicle due to the low-speed driving mode operation of a vehicle control device according to an embodiment of the present disclosure;

FIG. 4 is a graph illustrating acceleration and deceleration situations of a vehicle due to the high-speed driving mode operation of a vehicle control device according to an embodiment of the present disclosure;

FIG. 5 is a graph illustrating a braking situation during the high-speed driving mode operation of a vehicle control device according to an embodiment of the present disclosure;

FIGS. 6, 7, and 8 are graphs illustrating the effects of the operation of a vehicle control device according to an embodiment of the present disclosure; and

FIG. 9 is a flowchart illustrating a vehicle driving control method according to an embodiment of the present disclosure.

### DETAILED DESCRIPTION

In describing embodiments disclosed in the present specification, when the detailed description of the relevant known technology is determined to unnecessarily obscure the gist of the present disclosure, the detailed description may be omitted. Furthermore, the accompanying drawings are provided only for easy understanding of the embodiments disclosed in the present specification, and the technical spirit disclosed herein is not limited to the accompanying drawings, and it should be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for the purpose of distinguishing one element from another element.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

Hereinafter, embodiments disclosed in the present specification will be described in detail with reference to the accompanying drawings, and the same or similar elements are given the same and similar reference numerals, so duplicate descriptions thereof will be omitted.

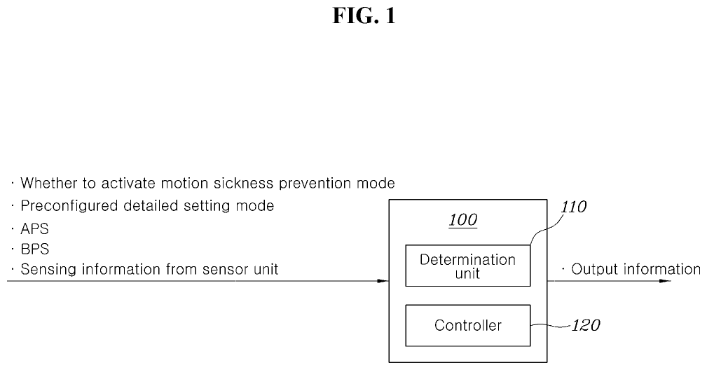

A vehicle control device according to an embodiment of the present disclosure will be described with reference to FIG. 1.

FIG. 1 is a block diagram illustrating the configuration of a vehicle control device according to an embodiment of the present disclosure.

Referring to FIG. 1, the vehicle control device 100 according to an embodiment of the present disclosure may include a determination unit 110 and a controller 120. FIG. 1 primarily shows elements related to an embodiment of the present disclosure. Furthermore, in the actual implementation of a vehicle control device, there may be fewer or more elements than those shown in FIG. 1.

Hereinafter, each element will be described.

The determination unit 110 may collect user-configured information about whether to activate a motion sickness prevention mode while a vehicle is driving. Whether to activate the motion sickness prevention mode may be configured in various manners. For example, whether to activate the motion sickness prevention mode may be configured by a driver by manipulating a predetermined manipulation device (e.g., a paddle shift disposed on a steering wheel or steering column). Alternatively, whether to activate the motion sickness prevention mode may be configured by a passenger, including a driver, by making a selection via a display device.

Additionally, the user-configured information may be configured through a driver's manipulation or a passenger's input during driving of the vehicle, and may refer to information preconfigured in the vehicle from the initial production stage. However, this is illustrative and the present disclosure is not necessarily limited thereto.

The determination unit 110 may determine, based on the collected user-configured information, whether the motion sickness prevention mode is entered, and when the motion sickness prevention mode is entered, may determine the vehicle's speed and compare the vehicle speed with a predetermined first reference speed. For example, the determination unit 110 may determine whether a driving function based on target vehicle speed tracking is active when the motion sickness prevention mode has been entered, and when the driving function is active, may determine the vehicle's speed and compare the vehicle speed with the predetermined first reference speed. In this case, the driving function based on target vehicle speed tracking may refer to a smart cruise control (SCC) function. In other words, it is assumed that the operation of the vehicle control device 100 according to an embodiment of the present disclosure will be performed while the smart cruise control function of the vehicle is active. Thus, when the driving function based on target vehicle speed tracking is not active, the determination unit 110 may output request information indicating that the driving function based on target vehicle speed tracking should be configured to be activated. However, this is illustrative and the present disclosure is not necessarily limited thereto.

In addition, when the motion sickness prevention mode has been entered, the determination unit 110 may determine one preconfigured detailed setting mode from among multiple detailed setting modes having different degrees of control intervention based on entering the motion sickness prevention mode. For example, multiple detailed setting modes may be pre-stored in the vehicle, and a driver or a passenger may configure one detailed setting mode among the multiple detailed setting modes in response to activation of the motion sickness prevention mode. Even in this case, the one detailed setting mode among the multiple detailed setting modes may be set in a way similar to the above-described way to configure whether to activate the motion sickness prevention mode. Furthermore, the preconfigured one detailed setting mode may vary depending on the sensitivity of the driver or passenger to motion sickness. However, this is illustrative, and the present disclosure is not necessarily limited thereto.

The predetermined first reference speed may be configured with various values, and in the present disclosure, the first reference speed may be 30 km/h. However, this is illustrative, and the present disclosure is not necessarily limited thereto.

The determination unit 110 may transmit the result of the comparison of the vehicle speed and the predetermined first reference speed to the controller 120. For example, when the vehicle's speed is equal to or lower than the first reference speed, the determination unit 110 may determine that the vehicle is in a low-speed driving situation and transmit, to the controller 120, a command to perform control based on the low-speed driving situation, and when the vehicle's speed exceeds the first reference speed, the determination unit 110 may determine that the vehicle is in a high-speed driving situation and transmit, to the controller 120, a command to perform control based on the high-speed driving situation. Furthermore, as described above, the determination unit 110 may transmit, to the controller 120, information about the one detailed setting mode determined from among the multiple detailed setting modes. Thus, the controller 120 may perform control in consideration of the one preconfigured detailed setting mode.

Based on the result of the comparison by the determination unit 110, the controller 120 may control the vehicle to reduce a change in longitudinal acceleration of the vehicle, or control the vehicle to reduce the feeling of acceleration or deceleration experience by a passenger in the vehicle in consideration of whether an obstacle is recognized. In other words, according to the result of the comparison by the determination unit 110, the controller 120 may control the vehicle in a case where the vehicle speed is equal to or lower than the first reference speed and in a case where the vehicle speed exceeds the first reference speed.

First, a case where the vehicle speed is equal to or lower than the first reference speed as a result of the comparison by the determination unit 110 will be described.

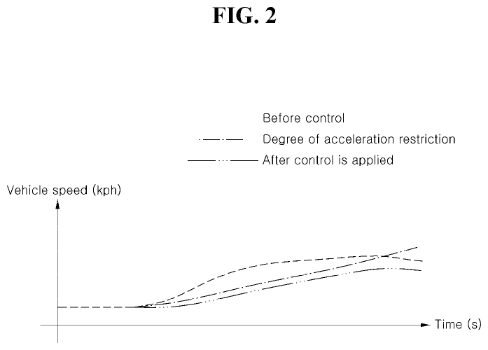

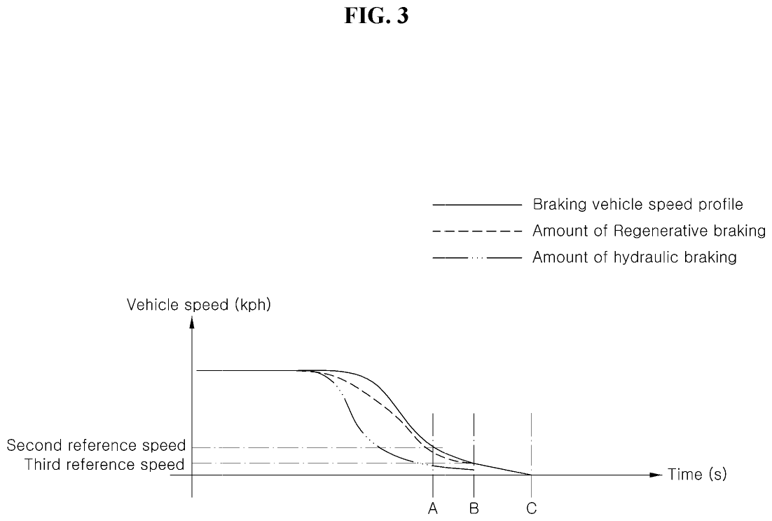

For example, when the vehicle speed is equal to or lower than the first reference speed, the controller 120 may control the vehicle in a low-speed driving mode in which a change in longitudinal acceleration of the vehicle is reduced. Specifically, when the vehicle speed is equal to or lower than the first reference speed, the vehicle may be recognized as being driven at a low speed, and the controller 120 may determine whether the vehicle is accelerating or decelerating in the low-speed driving situation. As a result of the determination, the controller 120 may control the vehicle in a first low-speed driving mode, in which the longitudinal acceleration of the vehicle is restricted, when the vehicle is accelerating, and may control the vehicle in a second low-speed driving mode, in which neutral N is applied when the vehicle's speed reaches a predetermined second reference speed and when the vehicle is decelerating. This will be described with reference to FIGS. 2 and 3.

FIGS. 2 to 3 are graphs illustrating acceleration and deceleration situations of a vehicle due to the low-speed driving mode operation of a vehicle control device according to an embodiment of the present disclosure.

First, the acceleration situation of the vehicle will be described with reference to FIG. 2.

FIG. 2 is a graph showing a change in a vehicle's speed over time when the vehicle accelerates in a low-speed driving situation. Conventionally, when accelerating in a low-speed driving situation, the operation of the vehicle control device 100 according to an embodiment of the present disclosure is not performed, and it can be observed that the vehicle speed suddenly increases in the initial interval where the acceleration is performed, as indicated by the dashed line graph shape (before control).

On the other hand, the vehicle control device 100 according to an embodiment of the present disclosure, in particular, the controller 120, may control the vehicle in a first low-speed driving mode in which the longitudinal acceleration of the vehicle is restricted during acceleration in the low-speed driving situation. Due to the operation of the controller 120, restriction on longitudinal acceleration of the vehicle may be configured as indicated by a dashed-single dotted line graph. Based thereon, the controller 120 may control the vehicle such that a change in the vehicle speed during the vehicle's acceleration is shown in the form of a dashed-triple dotted line graph in which the change in the vehicle speed does not exceed the configured longitudinal acceleration restriction (the dashed-single dotted line graph).

Therefore, when comparing, in the initial interval where acceleration is performed during the low-speed driving of the vehicle, the dashed line graph before applying the control operation of the controller 120 according to an embodiment of the present disclosure with the dashed-triple dotted line graph after applying the control operation of the controller 120, it can be observed that the degree of change in the slope of the dashed line graph before applying the control operation is greater than the degree of change in the slope of the dashed-triple dotted line graph after applying the control operation. In the graph of the vehicle speed over time, the slope may imply acceleration, and this may imply that a change in acceleration before the application of the control operation is greater than a change in acceleration after applying the control operation. In other words, the application of the control operation of the controller 120 according to an embodiment of the present disclosure may reduce the change in acceleration of the vehicle, in particular, the change in longitudinal acceleration, when accelerating in the low-speed driving situation, thereby preventing passengers, including a driver of the vehicle, from experiencing motion sickness.

Secondly, the deceleration situation of the vehicle will be described with reference to FIG. 3.

Referring to FIG. 3, in case that the vehicle is decelerating, the controller 120 may control the vehicle in a second low-speed driving mode in which the controller 120 applies neutral N when the vehicle's speed reaches a predetermined second reference speed. For example, the controller 120 may load or determine a preconfigured braking vehicle speed profile when controlling the vehicle in the second low-speed driving mode, and may control the vehicle to decelerate while following the loaded or determined braking vehicle speed profile. The braking vehicle speed profile is configured to reduce motion sickness of the driver or passengers when the vehicle is decelerating in the low-speed driving situation, and may be configured in the form of a solid line graph showing the change in vehicle speed over time illustrated in FIG. 3.

The controller 120 may control the vehicle to decelerate via regenerative braking at a higher ratio than hydraulic braking until the vehicle's speed reaches the predetermined second reference speed while following the braking vehicle speed profile. For example, as illustrated in FIG. 3, the controller 120 may reduce the amount of hydraulic braking and increase the amount of regenerative braking so that the regenerative braking contributes more to deceleration of the vehicle than the hydraulic braking. However, it should be understood that the regenerative braking amount graph and the hydraulic braking amount graph, illustrated in the graphs in FIG. 3, do not have the same physical amount as the braking vehicle speed profile, but only the shapes of the graphs are shown in order to easily describe changes in the deceleration of a vehicle following the braking vehicle speed profile.

The controller 120 may apply neutral N when the vehicle speed reaches the second reference speed according to the second low-speed driving mode (at time point A), and may control an input of a brake-pedal position sensor to be released when the vehicle's speed reaches a predetermined third reference speed (at time point B) while neutral N is applied. The releasing of the input of the brake-pedal position sensor may imply ignoring a sensing value that has been input through the existing brake-pedal position sensor. The controller 120 may control the input of the brake-pedal position sensor to be released at time B, thereby causing the vehicle to self-decelerate through coasting from time B to time C, during which the vehicle speed is equal to or lower than the predetermined third reference speed.

When the vehicle completely decelerates and stops by self-decelerating through coasting (at time point C), the controller 120 may activate the function of an electric parking brake (EPB), thereby bringing the vehicle to a complete stop. However, this is illustrative, and the present disclosure is not necessarily limited thereto.

Next, referring back to FIG. 1, a description will be made of a case in which the vehicle speed exceeds the first reference speed as a result of the comparison by the determination unit 110.

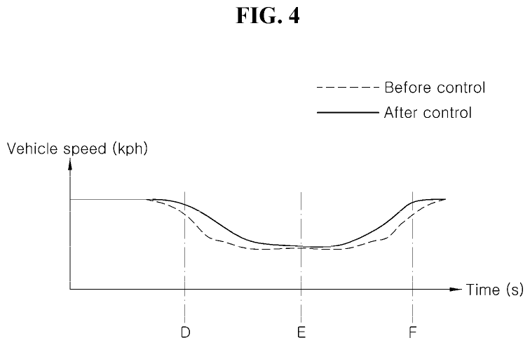

When the vehicle speed exceeds the first threshold speed, the controller 120 may control the vehicle in a high-speed driving mode, in which the feeling of acceleration or deceleration experience by a passenger in the vehicle is reduced, in consideration of whether an obstacle is recognized. Specifically, when the vehicle speed exceeds the first reference speed, the controller 120 may recognize that the vehicle is in a high-speed driving situation, and may determine whether the vehicle is accelerating or decelerating in the high-speed driving situation. As a result of the determination, the controller 120 may control the vehicle in a first high-speed driving mode, which is based on an acceleration torque profile generated to reduce the passenger's feeling of acceleration, when the vehicle is accelerating, and may control the vehicle in a second high-speed driving mode, which is based on a deceleration torque profile generated to reduce the passenger's feeling of deceleration, when the vehicle is decelerating. This will be described reference to FIG. 4.

FIG. 4 is a graph illustrating acceleration and deceleration situations of a vehicle due to the high-speed driving mode operation of a vehicle control device according to an embodiment of the present disclosure.

FIG. 4 illustrates a graph of a change in a vehicle's speed over time when the vehicle is accelerating or decelerating in a high-speed driving situation. The interval between time point D and time point E may indicate a situation where the vehicle is decelerating, and the interval between time point E and time point F may indicate a situation where the vehicle is accelerating. In the conventional case before the operation of controller 120 according to an embodiment of the present disclosure, i.e., before the control is applied (dashed graph), it can be observed that in the interval between time point D and time point E, the vehicle speed decreases rapidly due to the deceleration of the vehicle at the beginning of entering the interval. In the conventional case, it can be observed that the vehicle speed increases rapidly due to the acceleration of the vehicle in the interval between time point E and time point F. Thus, as the vehicle's speed changes rapidly, a driver or a passenger may strongly experience a feeling of acceleration or deceleration and experience motion sickness due to discomfort of the feeling of acceleration or deceleration.

Thus, in the interval between time point D and time point E, the controller 120 according to an embodiment of the present disclosure may control the vehicle to the second high-speed driving mode in which the vehicle decelerates based on a deceleration torque profile generated to reduce the passenger's feeling of deceleration. This allows the vehicle's speed to decrease more gradually in the interval between time point D and time point E compared with the conventional art, as shown by the solid line graph in FIG. 4. In the interval between time point E and time point F, the controller 120 may control the vehicle in the first high-speed driving mode in which the vehicle accelerates based on an acceleration torque profile generated to reduce the passenger's feeling of acceleration. This allows the vehicle's speed to increase more gradually in the interval between time point E and time point F compared with the conventional art, as shown by the solid line graph in FIG. 4.

The controller 120 according to an embodiment of the present disclosure may determine whether to control the vehicle in a high-speed driving mode, which includes the first high-speed driving mode and the second high-speed driving mode, in consideration of a mode release condition when controlling the vehicle in the high-speed driving mode.

Returning to FIG. 1, the controller 120 according to an embodiment of the present disclosure may have at least one of whether there is an obstacle in front of the vehicle and whether a driving function based on target vehicle speed tracking is active as a mode release condition, i.e., a condition for releasing the high-speed driving mode.

Specifically, when the vehicle's speed exceeds the first reference speed, the controller 120 may determine whether there is an obstacle in front of the vehicle. For example, the controller 120 may receive sensing information from a sensor unit disposed at the vehicle, and may determine, based on the received sensing information, whether there is an obstacle in front of the vehicle. In particular, the sensor unit may sense a range within a predetermined reference distance from the vehicle and provide sensing information, and the controller 120 may determine, based on the provided sensing information, whether there is an obstacle within the predetermined reference distance from the vehicle.

When there is no obstacle as a result of the determination, the controller 120 may control the vehicle in the high-speed driving mode. However, when there is an obstacle, the controller 120 may release the controlling of the vehicle in the high-speed driving mode in order to prepare for a collision between the obstacle and the vehicle, but may further consider additional conditions.

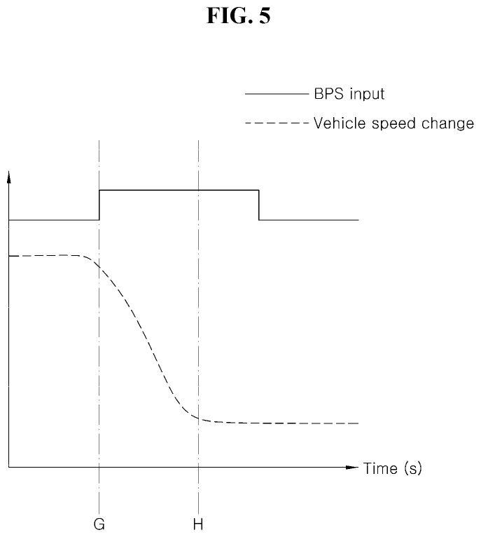

For example, the controller 120 may determine whether the driving function based on target vehicle speed tracking, determined by the determination unit 110 described above, is still active or inactive. For example, the controller 120 may receive, from the determination unit 110, information about whether the driving function based on target vehicle speed tracking is still active or inactive, to perform the determination, or may perform the determination directly. However, this is illustrative and the present disclosure is not necessarily limited thereto. Accordingly, when there is an obstacle, the controller 120 may determine whether the driving function based on target vehicle speed tracking is active or inactive, and when the driving function based on target vehicle speed tracking is active, the controller 120 may control the vehicle in the high-speed driving mode. This will be described with reference to FIG. 5.

FIG. 5 is a graph illustrating a braking situation during the high-speed driving mode operation of a vehicle control device according to an embodiment of the present disclosure.

Referring to FIG. 5, the graph may be, for example, a graph showing a vehicle speed change over time and an input of a brake-pedal position sensor (BPS), in a situation where a vehicle is traveling at a predetermined speed and then decelerates from time point G to time point H until the vehicle speed drops. For example, the vehicle speed at time point H may correspond to 0 km/h, and this is a graph showing a situation in which the vehicle drives at the predetermined speed and then decelerates until the vehicle comes to a stop. Therefore, it is possible to calculate, based on the above graph, a braking distance of the vehicle traveling at the predetermined speed until the vehicle comes to a stop. For example, based on the wheel speed of a vehicle at a predetermined speed, the elapsed time from time point G to time point H, and a sensing value of the brake-pedal position sensor, it is possible calculate the braking distance of the vehicle traveling at the predetermined speed until the vehicle comes to a stop. In addition, the braking distance may be calculated for each wheel speed of the vehicle or each sensing value of the brake-pedal position sensor and stored in the controller 120 in a data map format.

Thus, when there is an obstacle in front of the vehicle and when the driving function based on target vehicle speed tracking is active, the controller 120 may determine a distance from the vehicle to the obstacle, may load a braking distance corresponding to the sensing value of the current vehicle speed or the sensing value of the brake-pedal position sensor, and may control the driving of the vehicle based on the determined distance and the loaded braking distance. Therefore, when there is an obstacle in front of the vehicle, and when the driving function based on target vehicle speed tracking is active, the controller 120 may control the vehicle in the high-speed driving mode to safely protect the vehicle or the passenger.

It is assumed that the controller 120, according to an embodiment of the present disclosure, controls the vehicle while the driving function based on target vehicle speed tracking of the vehicle (e.g., a smart cruise control function) is active. Therefore, when there is an obstacle in front of the vehicle and when the driving function based on target vehicle speed tracking is inactive, the controller 120 may release control so as not to control the vehicle in the high-speed driving mode.

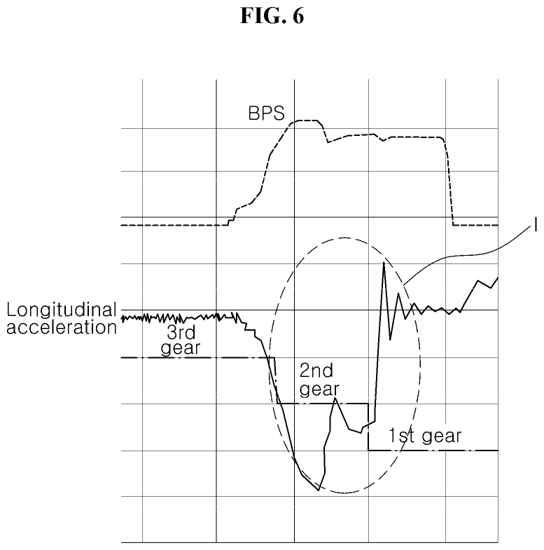

Hereinafter, the effects of operation of the vehicle control device 100 according to embodiments of the present disclosure will be described with reference to FIGS. 6 to 8.

FIGS. 6 to 8 are graphs illustrating the effects of operation of a vehicle control device according to an embodiment of the present disclosure.

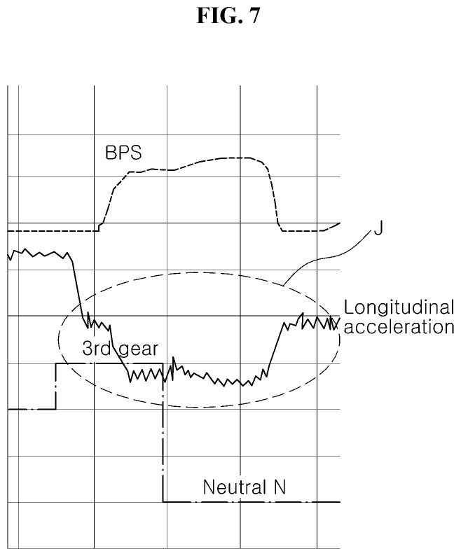

Firstly, the effect of controlling a vehicle in a low-speed driving mode of the controller 120 according to embodiments of the present disclosure will be described with reference to FIGS. 6 and 7.

FIG. 6 is a graph showing a change in each physical quantity in a conventional vehicle deceleration situation where the operation of the controller 120 according to an embodiment of the present disclosure is not performed. Referring to FIG. 6, a conventional vehicle was controlled to decelerate by sequentially downshifting a transmission from 3rd gear to 2nd gear and then from 2nd gear to 1st gear. Referring to section I, it can be observed that the longitudinal acceleration of the vehicle decreases rapidly at the moment of shifting from 3rd gear to 2nd gear, and then increases rapidly again at the moment of shifting from 2nd gear to 1st gear. In other words, in the past, the vehicle was controlled to decelerate by sequentially shifting gears in the transmission. However, this led to a significant change in longitudinal acceleration of the vehicle at the moment of gear shifting, and thus a driver and a passenger complained of motion sickness due to discomfort.

On the other hand, FIG. 7 is a graph depicting a change in each physical quantity resulting from controlling the vehicle in a low-speed driving mode, in particular, the second low-speed driving mode during deceleration of the vehicle, through the operation of the controller 120 according to an embodiment of the present disclosure. Referring to FIG. 7, the controller 120 according to an embodiment of the present disclosure is configured to, when the vehicle's speed reaches the predetermined second reference speed, immediately apply neutral N while the transmission is in 3rd gear so that the vehicle decelerates. Referring to section J, it can be observed that a change in longitudinal acceleration occurs at the moment of shifting from 3rd gear to neutral N, but a smaller degree of change in longitudinal acceleration occurs compared to section I in FIG. 6.

In other words, when the vehicle is controlled in the low-speed driving mode through the operation of the controller 120 according to an embodiment of the present disclosure, neutral N may be applied when the vehicle speed reaches the predetermined second reference speed, so that the change in longitudinal acceleration is reduced. Therefore, the driver and the passenger may feel less discomfort and may thus be prevented from experiencing motion sickness.

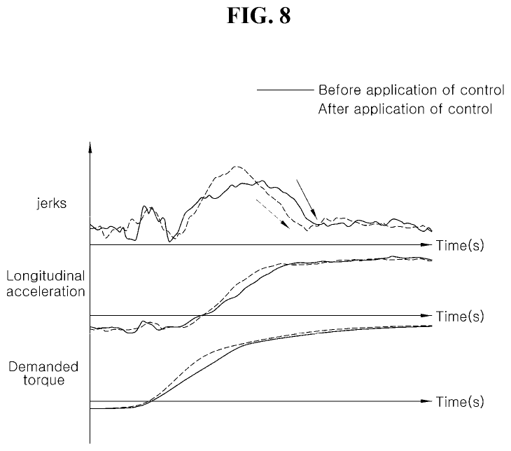

Secondly, the effect of controlling the vehicle in a high-speed driving mode of the controller 120 according to an embodiment of the present disclosure will be described with reference to FIG. 8.

Referring to FIG. 8, the horizontal axis may represent time, and the vertical axis may represent demanded torque, longitudinal acceleration, and jerk, respectively, and in particular, longitudinal acceleration based on demanded torque and jerk based on the demanded torque.

Solid line graphs each represent physical quantities before application of control through the controller 120 according to an embodiment of the present disclosure. Dashed line graphs each represent physical quantities after application of control through the controller 120 according to an embodiment of the present disclosure. It is assumed that FIG. 8 shows physical quantities measured during acceleration of a vehicle.

Referring to FIG. 8, when examining the graph of jerk based on demanded torque before the application of control, it can be observed that there is an interval in which jerk suddenly increases or decreases. This may eventually make the vehicle's passenger feel discomfort due to the perception of acceleration, and the passenger may complain of motion sickness due to the discomfort. On the other hand, when a control operation is applied through the controller 120 according to an embodiment of the present disclosure, demanded torque that tracks an acceleration torque profile may be applied. With the application of demanded torque, when examining the graph of jerk based on the demanded torque, it can be observed that there are intervals where jerk suddenly increases or decreases but the degree of increase or decrease is reduced compared with before the control is applied. Thus, application of the control of the controller 120 according to embodiments of the present disclosure may reduce the degree of increase or decrease in jerk compared with before the control is applied, thereby making the passenger feel less discomfort due to the perception of acceleration, and thus preventing the passenger from experiencing motion sickness due to the discomfort.

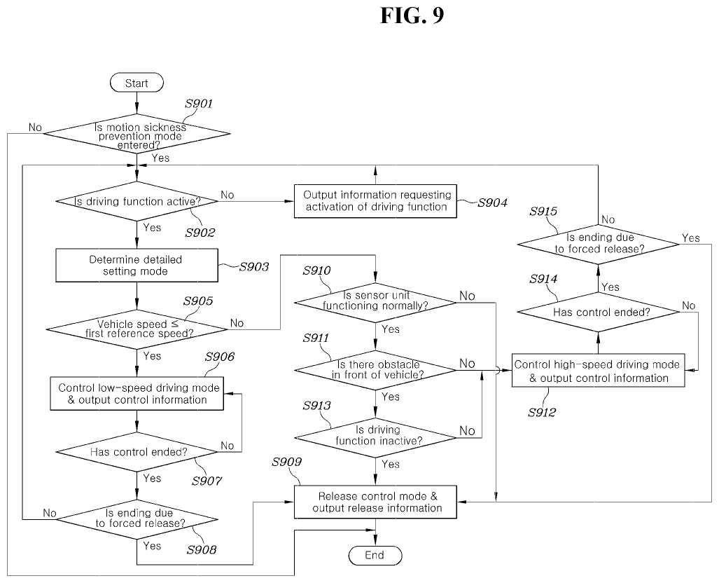

Hereinafter, based on the configuration of the vehicle control device 100 described above with reference to FIG. 1, a vehicle driving control method according to an embodiment of the present disclosure will be described with reference to FIG. 9.

FIG. 9 is a flowchart illustrating a vehicle driving control method according to an embodiment of the present disclosure.

Referring to FIG. 9, the determination unit 110 may determine whether a motion sickness prevention mode is entered, based on user-configured information about whether to activate the motion sickness prevention mode during the driving of the vehicle (S901). When the motion sickness prevention mode is entered (Yes in S901), the determination unit 110 may determine whether a driving function based on target vehicle speed tracking is active (S902). When the driving function based on target vehicle speed tracking is active (Yes in S902), the determination unit 110 may determine one preconfigured detailed setting mode among multiple detailed setting modes having different degrees of control intervention based on executing the motion sickness prevention mode (S903). If the driving function based on target vehicle speed tracking is not active (No in S902), the determination unit 110 may output request information indicating that the driving function based on target vehicle speed tracking should be configured to be activated (S904).

Thereafter, the determination unit 110 may determine a vehicle speed and compare the vehicle speed with a predetermined first reference speed (S905).

When the vehicle speed is equal to or lower than the first reference speed as a result of the determination by the determination unit 110 (Yes in S905), the controller 120 may control the vehicle in a low-speed driving mode in which a change in longitudinal acceleration of the vehicle is reduced, and may output control information about controlling the vehicle in the low-speed driving mode (S906). The controller 120 may control the vehicle in the low-speed driving mode until the vehicle reaches a target state, and may determine whether the control of the vehicle in the low-speed driving mode has ended (S907). When the control has ended (Yes in S907), the controller 120 may determine whether the ending is due to a forced release (S908). When the ending is not due to the forced release (No in S908), the controller 120 may continue to perform the control based on the execution of the motion sickness prevention mode. When the ending is due to the forced release (Yes in S908), the controller 120 may release the control of the vehicle in the low-speed driving mode and output information about the control release state (S909).

When the vehicle speed exceeds the first reference speed as a result of the determination by the determination unit 110 (No in S905), the controller 120 may determine whether a sensor unit provided in the vehicle is functioning normally (S910). When the sensor unit is functioning normally (Yes in S910), the controller 120 may determine whether there is an obstacle in front of the vehicle, based on a sensing information from the sensor unit (S911). When there is no obstacle in front of the vehicle (No in S911), the controller 120 may control the vehicle in a high-speed driving mode in which a feeling of acceleration or deceleration experience by a passenger in the vehicle is reduced, and may output control information about controlling the vehicle in the high-speed driving mode (S912). When there is an obstacle in front of the vehicle (Yes in S911), the controller 120 may determine whether the driving function based on target vehicle speed tracking is active (S913), and when the driving function based on target vehicle speed tracking is active (No in S913), the controller 120 may control the vehicle in the high-speed driving mode (S912). However, when there is an obstacle in front of the vehicle (Yes in S911) and when the driving function based on target vehicle speed tracking is inactive (Yes in S913), the controller 120 may release control so that the control of the vehicle in the high-speed driving mode is not performed, and may output information about the control release state (S909).

Furthermore, when the control of the vehicle in the high-speed driving mode is ended (Yes in S914), the controller 120 may determine whether the ending is due to a forced release (S915). When the ending is not due to the forced release (No in S915), the controller 120 may continue to perform the control based on to the execution of the motion sickness prevention mode. When the ending is due to the forced release (Yes in S915), the controller 120 may release the control of the vehicle in the high-speed driving mode and may output information about the control release state (S909).

As described above, the vehicle driving control method and the vehicle control device, according to the present disclosure, may compare a vehicle's speed with a predetermined first reference speed, and may control the vehicle in a low-speed driving mode, in which a change in longitudinal acceleration of the vehicle is reduced, when the vehicle speed is equal to or lower than the first reference speed as a result of the comparison, and may control, when the vehicle speed exceeds the first reference speed, the vehicle in a high-speed driving mode in which a feeling of acceleration or deceleration experience by a passenger in the vehicle is reduced. Therefore, the vehicle driving control method and the vehicle control device may prevent the occurrence of an abrupt change in longitudinal acceleration or reduce discomfort related to the passenger's feeling of acceleration or deceleration, thus preventing the passenger from experiencing motion sickness.

In addition, by providing a separate release condition when controlling the vehicle in the high-speed driving mode, the safety of both the vehicle and the passenger may be prioritized in situations where control is impossible.

The present disclosure as described above may be implemented as codes in a computer-readable medium in which a program is recorded. The computer-readable medium includes all types of recording devices in which data readable by a computer system are stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. Further, the above detailed description should not be construed in a limitative sense, but should be considered in an illustrative sense in all aspects. The scope of the present disclosure should not be determined by reasonable interpretation of the appended claims, and all changes and modifications within the equivalent scope of the present disclosure fall within the scope of the present disclosure.

Although the present disclosure has been described and illustrated in conjunction with particular embodiments thereof, it will be apparent to those skilled in the art that various improvements and modifications may be made to the present disclosure without departing from the technical idea of the present disclosure defined by the appended claims.

1. A vehicle driving control method comprising:
comparing a vehicle's speed with a predetermined first reference speed when a motion sickness prevention mode is entered based on user-configured information about whether to activate the motion sickness prevention mode during driving of the vehicle; and
controlling, based on a result of the comparison with the first reference speed, the vehicle to reduce a change in longitudinal acceleration of the vehicle or to reduce a feeling of acceleration or deceleration experienced by a passenger in the vehicle based on whether an obstacle is recognized.

2. The vehicle driving control method of claim 1, wherein the comparing comprises:
determining whether a driving function based on target vehicle speed tracking is active, when the motion sickness prevention mode is entered; and
comparing the vehicle's speed with the first reference speed when the driving function is active.

3. The vehicle driving control method of claim 1, comprising, before the controlling:
determining, when the motion sickness prevention mode is entered, one preconfigured detailed setting mode from among multiple detailed setting modes that have different degrees of control intervention based on entering the motion sickness prevention mode; and
controlling the vehicle based on the comparison result based on the one determined detailed setting mode.

4. The vehicle driving control method of claim 1, wherein the controlling further comprises controlling the vehicle in a low-speed driving mode, in which the change in longitudinal acceleration of the vehicle is reduced, when the vehicle speed is equal to or lower than the first reference speed as a result of the comparison, and controlling, when the vehicle speed exceeds the first reference speed, the vehicle in a high-speed driving mode in which at least one of an obstacle in front of the vehicle and the driving function based on target vehicle speed tracking is active is a mode release condition, and the feeling of acceleration or deceleration experienced by the passenger in the vehicle is reduced.

5. The vehicle driving control method of claim 4, wherein the controlling further comprises:
determining whether the vehicle is accelerating or decelerating when the vehicle speed is equal to or lower than the first reference speed; and
controlling the vehicle in a first low-speed driving mode, in which the longitudinal acceleration of the vehicle is restricted, when the vehicle is accelerating as a result of the determination, and controlling the vehicle in a second low-speed driving mode, in which neutral N is applied when the vehicle's speed reaches a predetermined second reference speed, when the vehicle is decelerating.

6. The vehicle driving control method of claim 4, wherein the controlling further comprises:
determining whether there is an obstacle in front of the vehicle in case that the vehicle speed exceeds the first reference speed; and
controlling the vehicle in the high-speed driving mode when the obstacle is not present.

7. The vehicle driving control method of claim 6, wherein the determining comprises determining whether the obstacle is present within a predetermined reference distance from the vehicle by using a sensor unit provided in the vehicle.

8. The vehicle driving control method of claim 6, wherein the controlling comprises controlling the vehicle in the high-speed driving mode when the driving function is active in case that the obstacle is present.

9. The vehicle driving control method of claim 4, wherein the controlling further comprises:
determining whether the vehicle is accelerating or decelerating when the vehicle speed exceeds the first reference speed; and
controlling the vehicle in a first high-speed driving mode, which is based on an acceleration torque profile generated to reduce the passenger's feeling of acceleration, when the vehicle is accelerating as a result of the determination, and controlling the vehicle in a second high-speed driving mode, which is based on a deceleration torque profile generated to reduce the passenger's feeling of deceleration, when the vehicle is decelerating.

10. A vehicle control device comprising:
a determination unit configured to compare a vehicle's speed with a predetermined first reference speed when a motion sickness prevention mode is entered based on user-configured information about whether to activate the motion sickness prevention mode during driving of the vehicle; and
a controller configured to control, based on a result of the comparison with the first reference speed performed by the determination unit, the vehicle to reduce a change in longitudinal acceleration of the vehicle or reduce a feeling of acceleration or deceleration experienced by a passenger in the vehicle based on whether an obstacle is recognized.

11. The vehicle control device of claim 10, wherein the determination unit is configured to:
determine whether a driving function based on target vehicle speed tracking is active, when the motion sickness prevention mode is entered; and
compare the vehicle's speed with the first reference speed when the driving function is active.

12. The vehicle control device of claim 10, wherein the determination unit is configured to determine, when the motion sickness prevention mode is entered, one preconfigured detailed setting mode from among multiple detailed setting modes that have different degrees of control intervention based on entering the motion sickness prevention mode, and
the controller is further configured to control the vehicle based on the comparison result based on the one detailed setting mode determined by the determination unit.

13. The vehicle control device of claim 10, wherein the controller is further configured to control the vehicle in a low-speed driving mode, in which the change in longitudinal acceleration of the vehicle is reduced, when the vehicle speed is equal to or lower than the first reference speed as a result of the comparison by the determination unit, and to control, when the vehicle speed exceeds the first reference speed, the vehicle in a high-speed driving mode in which at least one of an obstacle in front of the vehicle and the driving function based on target vehicle speed tracking is active is a mode release condition, and the feeling of acceleration or deceleration experienced by the passenger in the vehicle is reduced.

14. The vehicle control device of claim 13, wherein the controller is further configured to:
determine whether the vehicle is accelerating or decelerating when the vehicle speed is equal to or lower than the first reference speed; and
control the vehicle in a first low-speed driving mode, in which the longitudinal acceleration of the vehicle is restricted, when the vehicle is accelerating as a result of the determination, and control the vehicle in a second low-speed driving mode, in which neutral N is applied when the vehicle's speed reaches a predetermined second reference speed, when the vehicle is decelerating.

15. The vehicle control device of claim 13, wherein the controller is further configured to:
determine whether there is an obstacle in front of the vehicle when the vehicle speed exceeds the first reference speed; and
control the vehicle in the high-speed driving mode when the obstacle is not present.

16. The vehicle control device of claim 15, wherein the controller is further configured to determine whether the obstacle is present within a predetermined reference distance from the vehicle by using a sensor unit provided in the vehicle.

17. The vehicle control device of claim 15, wherein the controller is further configured to control the vehicle in the high-speed driving mode when the driving function is active in case that the obstacle is present.

18. The vehicle control device of claim 13, wherein the controller is further configured to:
determine whether the vehicle is accelerating or decelerating when the vehicle speed exceeds the first reference speed; and
control the vehicle in a first high-speed driving mode, which is based on an acceleration torque profile generated to reduce the passenger's feeling of acceleration, in case that the vehicle is accelerating as a result of the determination, and control the vehicle in a second high-speed driving mode, which is based on a deceleration torque profile generated to reduce the passenger's feeling of deceleration, when the vehicle is decelerating.
